(19) United States
(12) Patent Application Publication
(10) Pub. No.: US 2007/0263932 A1
(43) Pub. Date: Nov. 15, 2007

(54) System and method of gesture feature recognition

(75) Inventors: Laurent Bernardin, Kitchener (CA); Yu-Hong Wang, Scarborough (CA)

Correspondence Address: PEARNE & GORDON LLP, 1801 EAST 9TH STREET, SUITE 1200, CLEVELAND, OH, 44114-3108, US

(73) Assignee: Waterloo Maple Inc., Waterloo (CA)

(21) Appl. No.: 11/433,234

(22) Filed: May 12, 2006

(51) Int. Cl. G06K 9/00; G06F 3/033

(52) U.S. Cl. 382/187; 715/863

(57) ABSTRACT

A gesture feature recognition system and method is provided. The gesture feature recognition system comprises an input/output component for recording pen strokes and for displaying them as strokes on a display device, a repository for storing gesture recognition data and a recognizer component for analyzing the strokes using the gesture recognition data. The method comprises the steps of receiving input data that represents the stroke sequence of handwritten characters and symbols, comparing the input data to a predefined symbol set stored in a repository, identifying characters and symbols present in the input data, and identifying the location of relevant features of the characters and symbols.

### FIELD OF THE INVENTION

The invention relates generally to a system and method of gesture feature recognition.

### BACKGROUND OF THE INVENTION

There are systems for automatically recognizing handwritten symbols and characters using a pen device or similar method of input. In order to recognize handwritten input, composed of characters and symbols, it is not sufficient to simply identify general characters and symbols. The precise location of certain features of these of these characters and symbols also should be identified.

For example, to recognize a string of text, the baseline of each character should be identified. This is important, for example, to distinguish between the letter ‘g’ and the number ‘9’.

Another example of the need to identify the precise location of certain features occurs in recognizing mathematical formulae. For example, in addition to recognizing a (square) root symbol, one also has to identify the region that is “inside” the root symbol and differentiate it from the region that is “outside” the root symbol. The “inside” region will contain the argument of the root, whereas the “outside” region may contain the order (square, cubic, etc.) of the root.

One current way that the problem formulated above is presently addressed is to have feature identification code explicitly inserted for each character or symbol to be recognized. This interferes with training of the system, and in particular, with extensibility with additional characters and symbols. For Example, in addition to teaching the system to recognize a new character or symbol, explicitly coded instructions have to be provided to the system for each feature (baseline, etc.) that is recognized within that new character or symbol.

Another method that is presently being used identifies the handwritten characters and symbols with a stored model symbol. Since the feature locations are known in the model symbol, the feature location in the handwritten symbol can be approximated by scaling the location in the model to the size of the handwritten symbol. The fact that this method can only approximate the location of such features and may occasionally be incorrect, interferes with the recognition process of the overall input and leads to incorrect recognition results if these results are (partially) based on the supposed location of these features. For example, a ‘9’ may be recognized as a ‘g’ if the baseline is not accurately identified.

A system and method for more reliably finding the location for features in handwritten symbols is desired.

### SUMMARY OF THE INVENTION

In accordance with an embodiment of the invention, there is provided a gesture feature recognition system. The gesture feature recognition system comprises an input/output component for recording pen strokes and for displaying them as strokes on a display device, a repository for storing gesture recognition data and a recognizer component for analyzing the strokes using the gesture recognition data.

In accordance with another embodiment of the present invention, there is provided a method of gesture feature recognition. The method comprises the steps of receiving input data that represents the stroke sequence of handwritten characters and symbols, comparing the input data to a predefined symbol set stored in a repository, identifying characters and symbols present in the input data, and identifying the location of relevant features of the characters and symbols.

### BRIEF DESCRIPTIONS OF THE DRAWINGS

An embodiment of the invention will now be described by way of example only with reference to the following drawings in which:

FIG. 1 shows a gesture feature recognition system, in accordance with an embodiment of the present invention;

FIG. 2 show in a flowchart a method of gesture feature recognition, in accordance with an embodiment of the gesture feature recognition system;

FIG. 3 shows another example of a gesture feature recognition system;

FIG. 4 shows in a flowchart another method of gesture feature recognition, in accordance with an embodiment of the gesture feature recognition system;

FIGS. 5A and 5B depict examples of primitives, in accordance with an embodiment of the gesture feature recognition system;

FIG. 6 shows in a flowchart a method of decomposing or segmenting stroke and timing information of primitives, in accordance with an embodiment of the gesture feature recognition system;

FIG. 7 shows in a flowchart an example of a method of calculating a partial solution, in accordance with an embodiment of the gesture feature recognition system;

FIG. 8 shows the configuration at each step in the loop of steps (62) to (70) of the method described in FIG. 7;

FIG. 9 shows in a flowchart an example of a method of comparing a sequence of segmented primitives with a predefined sequence of primitives, in accordance with an embodiment of the gesture feature recognition system;

FIG. 10 shows in a flowchart an example of a method of performing a detailed match against a database entry with high probability of match, in accordance with an embodiment of the gesture feature recognition system;

FIG. 11 shows in a flowchart and example of a method of analyzing a correlation of features between an observation and base model to predict which shape is the baseline, in accordance with an embodiment of the gesture feature recognition system;

FIG. 12 shows in a flowchart an example of a method of approximating a baseline location of an observed sequence by observing the bounds of the corresponding baseline shape, in accordance with an embodiment of the gesture feature recognition system; and

FIG. 13 shows in a flowchart an example of a method of dynamic matching, in accordance with an embodiment of the gesture feature recognition system.

### DETAILED DESCRIPTION OF THE PREFERRED EMBODIMENTS

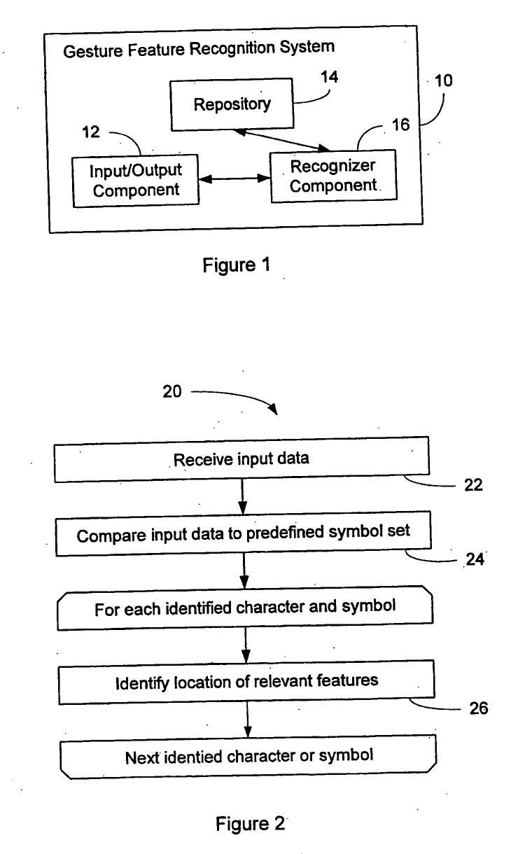

FIG. 1 shows a gesture feature recognition system 10, in accordance with an embodiment of the present invention. The gesture feature recognition system 10 comprises an input/output component 12 for recording pen strokes and for displaying them as strokes on a display device, a repository 14 for storing gesture recognition data, and a recognizer component 16 for analyzing the strokes using the gesture recognition data. The input/output component 12 includes a display panel that allows a user to input pen strokes using a stylus pen, mouse, or other pointing device. Other components may be added to the gesture feature recognition system 10.

FIG. 2 show in a flowchart a method of gesture feature recognition (20), in accordance with an embodiment of the gesture feature recognition system 10. The method begins with the gesture feature recognition system 10 receiving input data (22) that represents the stroke sequence of handwritten characters and symbols. The input data is compared to a predefined symbol set (24) stored in the repository 14. This comparison step (24) identifies characters and symbols present in the input data. For each such identified character or symbol, the gesture feature recognition system 10 identifies the location of relevant features (26). Once the location of relevant features is identified for each identified character or symbol (26), the method (20) is done (28). Other steps may be added to the method (20), including displaying digital characters or symbols that correspond to the identified characters or symbols, and outlining the identified relevant features in the display.

The predefined symbol set is produced during the training phase of the recognition system. For each symbol that needs to be recognized one or more hand-drawn instances of that symbol are produced and stored in the repository.

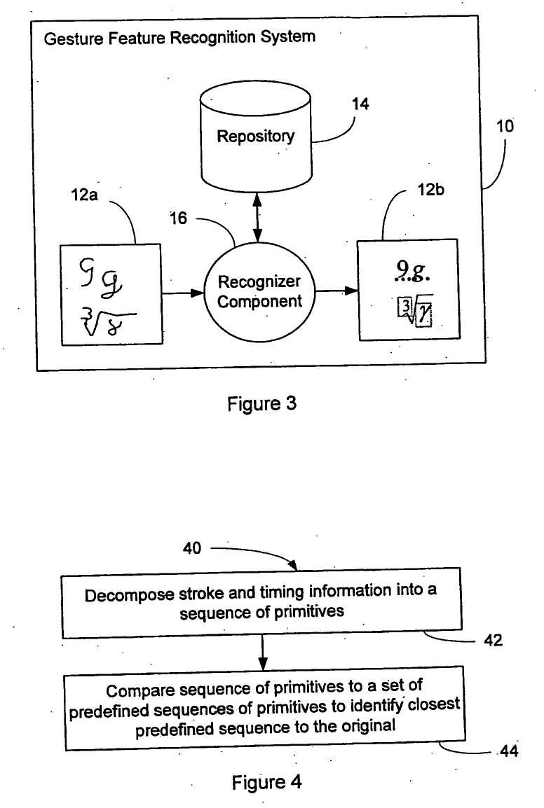

FIG. 3 shows another example of a gesture feature recognition system 10. In this example, the input/output component 12 is shown twice: once showing strokes received as input data 12a, and once showing the digital display of the input data 12b. Preferably, there is one input/output device 12 where input data is received and then displayed as digital data. Alternatively, there may be separate devices for the input of the input data and the output of the digital data. In the example provided in FIG. 3, the handwritten symbols for ‘9’, ‘g’ and the cubic root of gamma are correctly identified, along with the location of relevant features. The baselines 32 of ‘9’ and ‘g’ are marked with a dotted line and the “inside” 34 and “outside” 36 regions of the root symbol are marked with a dotted rectangle. A baseline on a text character refers to the vertical position on the character that would be aligned to the horizontal baseline of the text when drawing the character on a line of text.

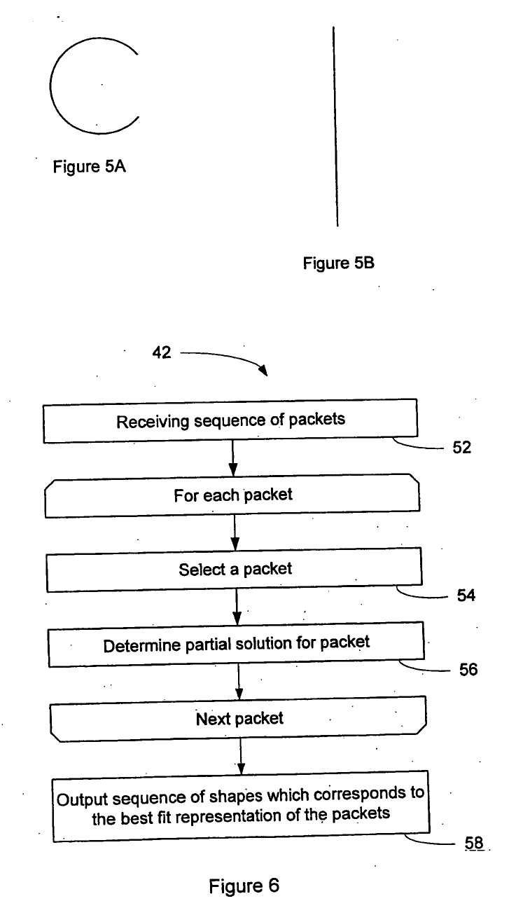

FIG. 4 shows in a flowchart another method of gesture feature recognition (40), in accordance with an embodiment of the gesture feature recognition system 10. The method begins with decomposing stroke and timing information (42) gathered by an input into a sequence of “primitives”. The set of such “primitives” may include lines, arcs, corners and intersections. For example, the stroke sequence for the character ‘q’ may result in the following sequence of two “primitives”:
An arc, drawn counter-clockwise, starting at an angle of 15 degrees and extending to an angle of 350 degrees (see FIG. 5A); and
A straight, vertical line, drawn downwards, connected to the first primitive at the top end (see FIG. 5B).
   Next, this sequence of “primitives” is compared to a set of predefined sequences of “primitives” (44). The goal of this comparison step (44) is to identify the predefined sequence that is “closest” to the original one. The set of predefined primitives includes feature location information within each sequence of primitives. For example, a predefined sequence of primitives representing the character q may be composed of the following four primitives:
An arc, drawn counter-clockwise
A “baseline bounding box marker”, indicating that the baseline of the character is at the lowest coordinate of all strokes that appear prior to this primitive.
A vertical line, drawn downwards
A horizontal line, intersecting the vertical one
   Once a set of sequences corresponding to the primitives is identified (44) the method is done (46). Other steps may be added to the method (40), including displaying the identified set of sequences in an output or input/output device 12.

Before a recognition is initiated, the set of predefined sequences of primitives is created. This is achieved by gathering stroke data for each symbol to be recognized and then using the process described above to decompose this stroke data into primitives. These sequences of primitives are stored in a repository such that they can be reused for multiple recognitions. Feature location information is manually inserted into each sequence of primitives, if required. Typically such a repository would be created during the “training” phase of building a recognition system.

FIG. 6 shows in a flowchart a method of decomposing or segmenting stroke and timing information of primitives (42), in accordance with an embodiment of the gesture feature recognition system 10. The method begins with receiving a sequence of packets (52). Input is a discrete sequence of packets representing stroke data. Next, a packet is selected (54). A partial solution is determined (56) based upon each packet selected to this point. The partial solution may be determined using a dynamic segmentation method. Partial solutions are calculated starting from the last packet to the first, in reverse order. The final solution corresponds to the partial solution beginning at the first packet. If all packets have been processed (58) then a sequence of shapes which correspond to the best fit representation of the input packets is outputted (59). Otherwise, the next packet is selected (54).

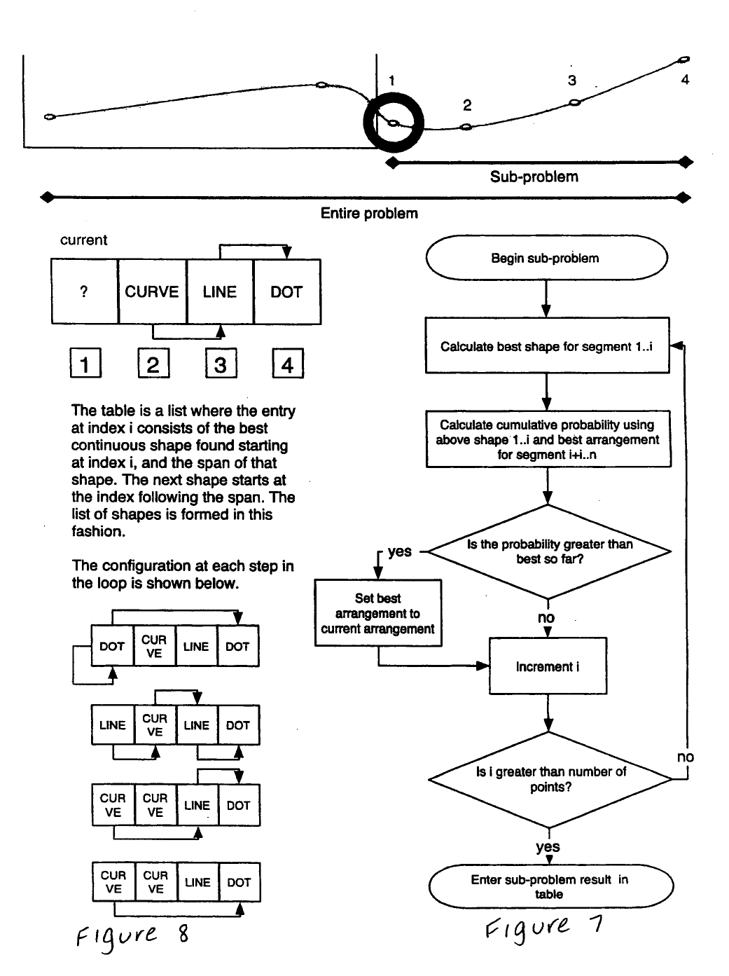

FIG. 7 shows in a flowchart an example of a method of calculating a partial solution, in accordance with an embodiment of the gesture feature recognition system 10. The method begins with calculating a “best” shape for segment 1 . . . i (62), where i denotes the level of the packet selection. Next, the cumulative probability using the “best” shape 1 . . . i and best arrangement for segment i+i . . . n is calculated (64), where n denotes the number of points. A stroke consists of n points in two-dimensional space, where n is an integer greater than zero. The stroke itself is uniquely represented by an ordered sequence of such points. Since the sequence of points is ordered, we can label each point with a number from 1 to n. The variable i denotes the number of a point in the stroke. At each iteration of the method, the points that lie in the range of 1 to i are considered. The variable i is incremented at each iteration. “Points” denote the individual two-dimensional points, or pairs of numbers of the form (x, y), which form the stroke. In the analysis of stroke shapes, there are certain shape primitives. These primitives include (but may not be limited to) lines, curves, dots, and loops.

For example, suppose t shape primitives are defined and denoted S1 to St, where t is an integer greater than 0. For each shape Sj, a distance function d[Sj] exists. The function d[Sj] takes as an argument a sequence of points {p1, . . . , pq}, and returns a real number greater than or equal to zero. This distance function is called a metric. It can be considered a measure of similarity between the shape Sj and the sequence of points {p1, . . . , pq}. “Best” or “optimal” arrangement refers to the choice of shape S (from the set of shapes {S1, . . . , St}) such that the similarity reported by d[S]({p1, . . . , pq}) is greatest. For instance, the distance function for the “line” shape, when applied to a stroke where all the points are collinear, would report a greater amount of similarity than the distance functions for the “curve” shape, “dot” shape, or “loop” shape when applied to the same stroke. If the probability calculated in step (64) is greater than the best arrangement so far, then the best arrangement is set to the current arrangement (66). Otherwise (64), i is incremented by one (68). If i is greater than the number of points (70), then the current best arrangement is entered in a table (72). Otherwise (70), the best shape for segment 1 . . . i is calculated (62).

The table is a list where the entry at index i consists of the best continuous shape found starting at index i, and the span of that shape. The next shape starts at the index following the span. The list of shapes is formed in this fashion. FIG. 8 shows the configuration at each step in the loop of steps (62) to (70) of the method described in FIG. 7.

By matching corresponding primitives in the original sequence and the sequence that was identified as the “closest” in the predefined set, the position in the original sequence to insert any feature location markers is identified. It is desirable to insert the markers in the original sequence which best correspond to the position of the markers in the target sequence. The target sequence is the model that is used as a reference in the system. It is stored in memory, possibly as an entry in a database or repository. The location of all the markers in all target models are known with certainty. The original is an unknown model that is to be matched to an existing model in the database. At this point in the method, it is determined that the target sequence matches the original with a measure of certainty above some predefined threshold. The location at which a particular marker should be inserted in the original is estimated. The estimate is based on the surrounding features and position of the marker in the target.

In the example of FIG. 8, arc in the original sequence is matched with the arc in the target sequence and the vertical line in the original sequence is matched with the vertical line in the target sequence. The extra horizontal line in the target sequence is identified as missing from the original sequence. Since the baseline marker appears in between the arc primitive and the vertical line primitive, the baseline marker is inserted between the arc primitive and the vertical line primitive in the original sequence. The original sequence of primitives, augmented with the baseline marker now looks as follows:
An arc, drawn counter-clockwise, starting at an angle of 15 degrees and extending to an angle of 350 degrees
A “baseline bounding box marker”, indicating that the baseline of the character is at the lowest coordinate of all strokes that appear prior to this primitive.
A straight, vertical line, drawn downwards, connected to the first primitive at the top end.
   The location of all features for which information was present in the target sequence is now identified. In the example of FIG. 8, the location of the baseline is located by computing the lowest coordinate that was present in the original stroke information for primitives that occur prior to the baseline marker. That is, the lowest coordinate of the stroke information that was identified as the counter-clockwise arc.

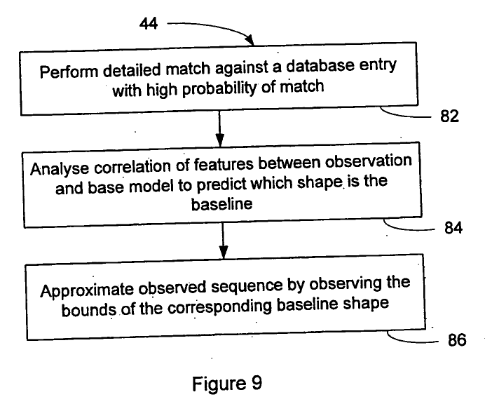

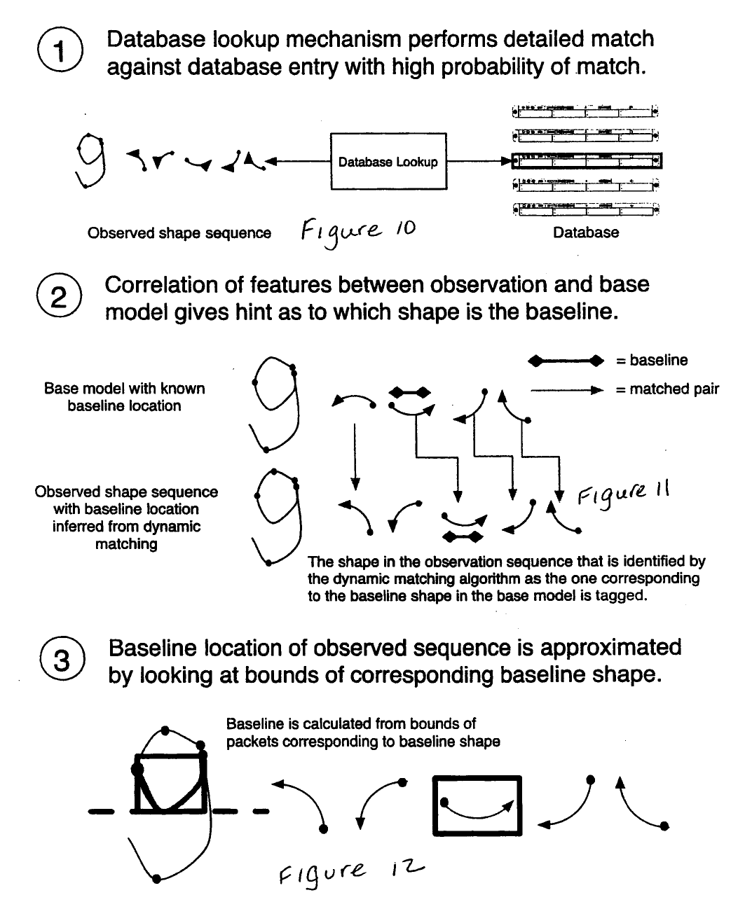

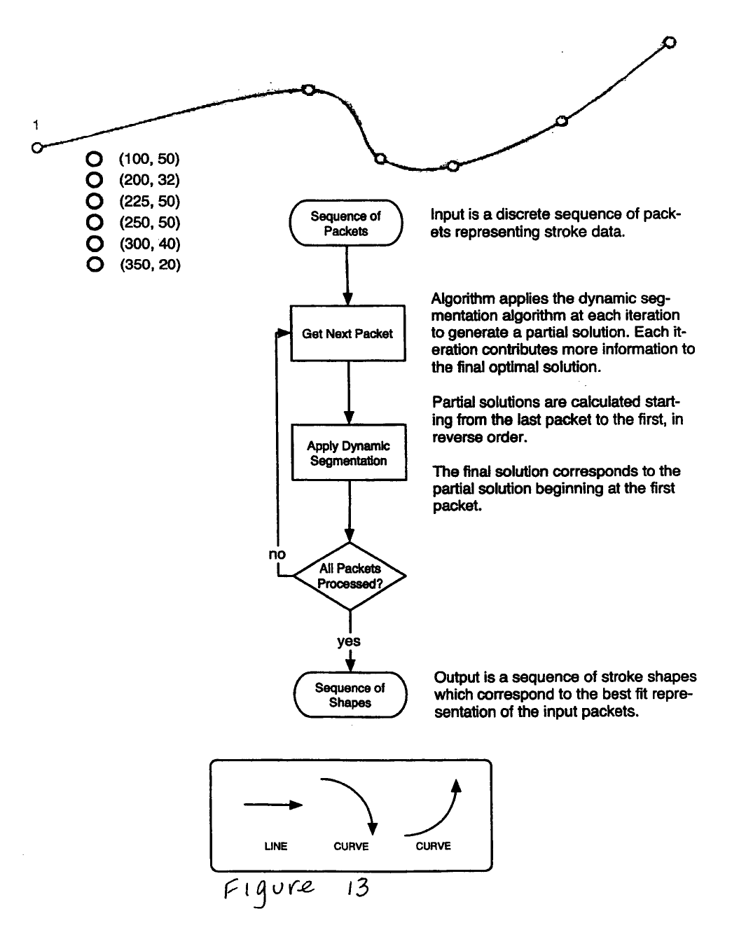

FIG. 9 shows in a flowchart an example of a method of comparing a sequence of segmented primitives with a predefined sequence of primitives (44), in accordance with an embodiment of the gesture feature recognition system. The method begins with a database lookup mechanism performing a detailed match against a database entry with high probability of match (82). This step is illustrated in FIG. 10, using an observed shape sequence of primitives 92 for the number ‘9’. Next, a correlation of features between the observation and base model is analyzed to predict which shape is the baseline (84). This step is illustrated in FIG. 11. A base model with a known baseline location 94 is shown along with primitives 92. An observed shape sequence with an inferred baseline location from dynamic matching 96 is also shown in FIG. 11. The primitives 92 are matched. Once the correlation analysis (84) is complete, a baseline location of the observed sequence is approximated by observing the bounds of the corresponding baseline shape (86). This step is shown in FIG. 12, where a baseline is calculated from the bounds of packets corresponding to a baseline shape.

If the predefined set of sequences contains sequences for all characters and symbols in the alphabet that are desired to be recognized, the characters and symbols themselves are identified as a side effect of locating their features. However, a separate recognizer can also be used to identify the characters and symbols, which enables a mode of only supplying the subset of predefined sequences to the feature locator, that correspond to the character or symbol that was recognized.

When comparing two sequences of primitive, how “close” these two sequences are is determined as determining the sequence from a collection of sequences, which is “closest” to the target sequence is a critical step in the method (44), as seen in FIGS. 10 to 12.

First, how to characterize the “closeness” of two individual primitives is defined. A numeric measure between 0.0 and 1.0 is assigned, where 0.0 means that the primitives are identical, 1 means that the primitives are fully distinct and a value between 0.0 and 1.0 indicates a progressively more distant resemblance between the two primitives. If the primitives are not of the same type (e.g., they are not both lines or not both arcs), a measure of 1.0 is assigned and comparison is stopped. If the primitives are of the same type, detailed properties of the two primitives are analyzed, which depend on the type of the primitive. For example, for a line, these properties would include the length of the line and the angle of the line. For an arc, the properties would include the arc length, the starting angle and the ending angle. The closer the numeric values for these properties are, the smaller the value for the “closeness” that gets assigned.

Next, how to characterize “closeness” between two sequences of primitives is defined. The method begins with a value of 0.0 for the tentative “closeness” of these two sequences. A “current position” for both sequences is defined and initialized at the beginning of both sequences. The “closeness” of the two primitives at the “current position” of both sequences is evaluated using the method (44) above. If this value is above a certain threshold, say 0.9, the “closeness” of the next element in the first sequence is computed with the current element in the second sequence as well as the “closeness” of the next element in the second sequence with the current element in the first sequence. If the minimum value of these two computations is above the threshold (the threshold can, for example, have a value of 0.9), a penalty value is added, say 0.1, to the overall “closeness” value for the two sequences, increment the “current position” for both sequences and iterate as above until one of the sequences is exhausted. If there are primitives left in the other sequence, a penalty of 0.1 is added, multiplied with the number of left over sequences to the overall “closeness” value and return the latter. If the minimum value of the two computations above is below the threshold (0.9), a penalty for a “missing primitive” is added, say 0.05 to the overall “closeness” value, increment the “current position” for the sequence where the next primitive more closely matched the primitive at the “current position” of the other sequence and iterate as above.

At the end of this process a “closeness” measure is computed which indicates how similar the two sequences of primitives are. Other measures of “closeness” can be used as long as they have the property that low values are assigned for two sequences of primitives corresponding to similar pen strokes and high values are assigned for two sequences corresponding to strokes that are different. Alternate techniques can be used to compare two sequences of primitives, instead of the approach described above. For example, standard techniques commonly used in the field of bioinformatics can be applied.

A method of dynamic matching can be used as an alternative to the process above for the step (44) of finding “close” matches of sequences of primitives in a database. Advantageously, the method of dynamic matching has the following characteristics:
1. To be able to search for inexact matches within a b-tree data structure efficiently, and associate a measure of “closeness” with each potential match.
2. To perform this search with little auxiliary storage.
3. To be able to account for extra or missing shapes in the sequence when looking for candidates in the database.
4. To accurately score the “closeness” of each match between observation sequence and database record.

A description of the b-tree is provided, the data structure used for the database. A b-tree is also known as a multi-way search tree. It is useful for storing a database of words over an alphabet. For example, a dictionary of English words can be stored as a b-tree where the alphabet corresponds to the Roman alphabet. A series of telephone numbers can also be stored in a b-tree should the need arise to index and look up entries in a database by telephone number. In this case, the alphabet would correspond to digits in the phone number. Alphabets can also consist of abstract symbols; in the feature gesture recognition system 10, alphabets are stroke shapes that are recognized by the tokenization process. An alphabet in the feature gesture recognition system 10 comprises a finite number of letters.

It is similar in concept to a linked list, with multiple “next” nodes branching from a single node. Each “next” node corresponds to a letter in the alphabet. Suppose that we are at a node n which is k levels deep from the root. Then n corresponds to the prefix of some word in the tree A₁A₂ . . . Aₙ whose letters correspond to the path of “next” nodes required to reach n from the root. There exists a pointer at the “next” node corresponding to letter X in the alphabet, if and only if there exists a word with prefix A₁A₂ . . . AₙX in the tree. Otherwise, the “next” node corresponding to X at n is empty (null).

An advantage of such a data structure is that it can be searched efficiently for exact matches while maintaining storage efficiency. In addition, it admits an efficient method to search for inexact matches against an input sequence. The latter method is not an exhaustive search, but is able to produce correct matches with high degree of probability. It is in this method that baseline extrapolation through correspondence of shapes in the sequence is performed.

The impetus driving the development of a method of dynamic matching is the desire to perform comparisons between two data sets when the data are different and a measure of similarity is required. The dynamic matching approach is able to determine the optimal set of constraints under which the similarity measure is at its greatest, while running in polynomial time.

The method of dynamic matching described above employs an intermediate data structure, a priority queue, to maintain a record of the best full and partial matches found so far at any point in the method. The method of recording critical feature correspondence between base and observation also uses this data structure.

When comparing two sequences, it is traditional to consider “current” characters in both sequences. At each iteration in the method of dynamic matching, different choices for the “current” characters are used and the partial match score is adjusted. There are three choices for score adjustment. Suppose that the current characters in the two sequences are at indices i and j, respectively.
1. Take the score from comparing the two current characters and apply it to the cumulative best score from the substring that was found by comparing until indices i−1 and j−1 in the two lists.
2. Skip the character at index i in the first list, and apply a constant “skip character in first list” penalty to the measurement to the score from the substring formed by indices i−1 and j.
3. Skip the character at index j in the second list, and apply a constant “skip character in second list” penalty to the measurement to the score from the substring formed by indices i and j−1.
   The choice with the greatest score, or measurement of similarity, is chosen as the partial solution for the sub-problem at indices i and j.

The comparison starts with both indices at 1 (the base case, where the comparison is done on two strings of length 1), and iterates by alternately incrementing each index until the length of both strings is exhausted. The final result is a score computed at the final character of both strings.

The method of dynamic matching as described may be used over two arrays, across which can be traversed by index. To adapt this to the b-tree, note that several cases that arise during the iteration of the method of dynamic matching that correspond to degenerate cases which would almost never be applicable as a final solution. These boundary conditions include the case where the current symbols under consideration differ by a sufficient number of indices that the penalty for skipping so many symbols makes the match unviable. In the majority of cases, we such conditions are ignored without affecting the correctness of the matching.

It is the above fact that allows the method to be used over a b-tree. Instead of indices, pointers are used to nodes in the tree to track our progress through the list that exists within the b-tree. An index i is associated with the position of each “current” symbol in the observation sequence with the pointer and maintain a score in the same way as described in the method (120).

This approach has the advantage that it can be employed with a priority queue to perform an optimized A * search of the database. This means that an extension of the dynamic matching algorithm, which is designed to compare only two lists at once, can be used to compare multiple lists and search the database. The disadvantage is that by performing a search in this manner, an exhaustive search is no longer required. Thus by adopting this method, the results might miss some potential matches that would otherwise be found by an exhaustive search.

For the purposes of finding corresponding shapes for feature extraction, an extra calculation is performed if choice 1 was taken in the above method. If there is a baseline marker at the shape in the base sequence, then occurrence is recorded to indicate which index in the observed sequence corresponds to the baseline shape. This information is recorded in the partial match. If the partial match leads to a fall solution that is returned as a candidate, then this information is propagated to the final solution. The method in which the information is stored and propagated is specific to the implementation, and can be performed with a custom data structure.

The system and method described above identify the precise location of features in online recognition of handwritten characters and symbols, i.e., in the presence of stroke and timing information.

Advantageously, the approach enables the system to identify the location of features in handwritten characters and symbols with high precision, and without sacrificing a straightforward training phase or extensibility with additional characters and symbols.

The systems and methods according to the present invention may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A gesture feature recognition system, the gesture feature recognition system comprising:
an input/output component for recording pen strokes and for displaying them as strokes on a display device;
a repository for storing gesture recognition data; and
a recognizer component for analyzing the strokes using the gesture recognition data.

2. The gesture feature recognition system as claimed in claim 1, wherein the input/output component includes a display panel that allows a user to input pen strokes using a pointing device.

3. A method of gesture feature recognition, the method comprising the steps of:
receiving input data that represents the stroke sequence of handwritten characters and symbols;
comparing the input data to a predefined symbol set stored in a repository;
identifying characters and symbols present in the input data; and
identifying the location of relevant features of the characters and symbols.

4. The method as claimed in claim 3, further comprising the step of displaying digital characters or symbols that correspond to the identified characters or symbols.

5. The method as claimed in claim 3, further comprising the step of outlining the identified relevant features in the display.

6. A method for encoding strokes representing characters or symbols using shape primitives with interspersed feature location information.

7. A method for encoding strokes representing characters and symbols using primitive shapes like lines, arcs, points and loops, with interspersed information for locating features like baselines and particular points and regions in hand-drawn symbols.

8. A method for creating a repository of sequences of shape primitives and feature location information, that can be used by a symbol recognition.

9. A method for matching handwritten characters against a model structure that contains feature location information.

10. A method for mapping feature location information found within a model symbol to the corresponding location within a handwritten symbol.

11. A method for detection the baseline of handwritten characters with high precision.

12. A method for differentiating between the inside and outside region of a hand-drawn root symbol.
